(19) United States
(12) Patent Application Publication
(10) Pub. No.: US 2025/0006160 A1
(43) Pub. Date: Jan. 2, 2025

(54) MIDI MUSIC FILE GENERATION METHOD, STORAGE MEDIUM AND TERMINAL

(71) Applicant: Tencent Music Entertainment Technology (Shenzhen) Co., Ltd., Shenzhen (CN)

(72) Inventor: Yiyong Jiang, Shenzhen (CN)

(73) Assignee: Tencent Music Entertainment Technology (Shenzhen) Co., Ltd., Shenzhen (CN)

(21) Appl. No.: 18/708,541

(22) PCT Filed: Oct. 26, 2022
(86) PCT No.: PCT/CN2022/127590

§ 371 Date: May 8, 2024

(30) Foreign Application Priority Data
Dec. 31, 2021 (CN) 202111676119.7

(51) Int. Cl. G10H 1/02; G10H 1/00

(52) U.S. Cl. CPC G10H 1/02; G10H 1/0066

(57) ABSTRACT

A method for generating a Midi file, a storage medium and a terminal are provided. The method includes: acquiring notation data of to-be-configured music, and determining a musical instrument corresponding to the music; determining the number of audio tracks in the Midi file based on the number of strings of the musical instrument; reading a chord from the notation data, and determining a string identifier of the musical instrument corresponding to the chord by searching a playing technique data table; determining a fingering corresponding to the string identifier by searching a chord fingering data table; determining a scale corresponding to the chord based on the fingering, and determining a scale sequence comprising scales based on a chord order; and determining a playing style of each meter in the scale sequence, and writing the scale sequence and the playing styles into the respective audio tracks, to generate the Midi file.

The present application claims the priority to Chinese Patent Application No. 202111676119.7, titled “MIDI MUSIC FILE GENERATION METHOD, STORAGE MEDIUM AND TERMINAL”, filed on Dec. 31, 2021 with the China National Intellectual Property Administration, which is incorporated herein by reference in its entirety.

### FIELD

The present disclosure relates to the technical field of computers, and in particular to a method for generating a Midi file, a storage medium and a terminal.

### BACKGROUND

Music is generally performed with music notations. However, it is difficult to properly play musical notes or tune, which inconveniences the players.

Therefore, how to assist players in practicing musical instruments is a technical problem to be urgently addressed by those skilled in the art.

### SUMMARY

A method for generating a Midi file, a storage medium and a terminal are provided according to the present disclosure, to generate a Midi file corresponding to notation data for assisting users in practicing musical instruments.

In order to address the above technical problem, the method for generating the Midi file according to the present disclosure includes: acquiring notation data of to-be-configured music, and determining a musical instrument corresponding to the to-be-configured music; determining the number of audio tracks in the Midi file based on the number of strings of the musical instrument; reading a chord from the notation data, and determining a string identifier of the musical instrument corresponding to the chord by searching a playing technique data table; determining a fingering corresponding to the string identifier by searching a chord fingering data table; determining a scale corresponding to the chord based on the fingering, and determining a scale sequence comprising scales based on a chord order; and determining a playing style of each of meters in the scale sequence, and writing the scale sequence and the playing styles into the respective audio tracks, to generate the Midi file.

In an embodiment, the determining the playing style of each of the meters in the scale sequence includes: determining a playing technique of the musical instrument and the number of beats per minute corresponding to the notation data; determining an arrangement of strongness and weakness based on the number of beats per minute; determining the number of times that each of the beats is to be played based on the playing technique; and determining the finger strength of each of meters in the scale sequence based on the arrangement and the number of times that each of the beats is to be played.

In an embodiment, the playing technique is fingerstyle, and the determining the finger strength of each of meters in the scale sequence based on the arrangement and the number of times that each of the beats is to be played includes: determining, for each of the beats based on the arrangement, the finger strength when the beat is to be played for a first time; and determining the finger strength when the beat is played subsequently as weak.

In an embodiment, the playing technique is sweep-picking, and the determining the finger strength of each of meters in the scale sequence based on the arrangement and the number of times that each of the beats is to be played includes: determining initial finger strength based on the arrangement; and arranging finger strength of the scales for certain number of beats in the scale sequence in descending order from the initial finger strength as time goes on.

In an embodiment, the determining the finger strength of each of meters in the scale sequence based on the arrangement and the number of times that each of the beats is to be played includes: acquiring a beat strength value table; determining, for each of the beats, strength of the beat when to be played each time based on the arrangement; determining a finger strength value corresponding to the strength of the beat from the beat strength value table; and establishing a mapping relationship between the finger strength value and the number of times that the beat is to be played, to obtain the finger strength of each of the meters in the scale sequence.

In an embodiment, the method further includes: establishing the playing technique data table corresponding to the musical instrument based on playing techniques of the musical instrument, before the determining the string identifier of the musical instrument corresponding to the chord by searching the playing technique data table.

In an embodiment, the method further includes: collecting fingerings and respective chords of the musical instrument to generate the chord fingering data table, before the determining the fingering corresponding to the chord by searching the chord fingering data table for the string identifier.

In an embodiment, the method further includes: adding the number of beats per minute, a time signature of the notation data, and the playing technique to the Midi file, after the Midi file is generated.

A computer-readable storage medium is further provided according to the present disclosure. The computer-readable storage medium stores a computer program that, when being executed by a processor, performs the method described above.

A terminal is further provided according to the present disclosure. The terminal includes a memory and a processor. The memory is configured to store a computer program. The processor is configured to invoke the computer program in the memory to perform the method described above.

The method for generating the Midi file is provided according to the present disclosure. The method includes: acquiring notation data of to-be-configured music, and determining a musical instrument corresponding to the to-be-configured music; determining the number of audio tracks in the Midi file based on the number of strings of the musical instrument; reading a chord from the notation data, and determining a string identifier of the musical instrument corresponding to the chord by searching a playing technique data table; determining a fingering corresponding to the string identifier by searching a chord fingering data table; determining a scale corresponding to the chord based on the fingering, and determining a scale sequence comprising scales based on a chord order; and determining a playing style of each of meters in the scale sequence, and writing the scale sequence and the playing styles into the respective audio tracks, to generate the Midi file.

According to the embodiment of the present disclosure, the generated Midi file includes the fingering, the playing technique, the scale, and the finger strength, for the player to learn how to play each of the chords and then play the chords steadily with the Midi file. The player can perform a quick switch between the chords, rapidly master various playing techniques, and play and sing simultaneously. Therefore, the method effectively assists the player in practicing the musical instrument.

The computer-readable storage medium and the terminal according to the present disclosure also have the beneficial effects described above.

### BRIEF DESCRIPTION OF THE DRAWINGS

In order to more clearly illustrate technical solutions in embodiments of the present disclosure or in the conventional technology, the drawings to be used in the description of the embodiments or the conventional technology are briefly described below. It is apparent that the drawings in the following description show only some embodiments of the present disclosure, and other drawings may be obtained by those skilled in the art from the drawings without any creative work.

FIG. 1 is a flow chart illustrating a method for generating a Midi file according to an embodiment of the present disclosure;

FIG. 2 is a schematic diagram illustrating some chords and respective fingerings according to an embodiment of the present disclosure;

FIG. 3 is a schematic diagram illustrating a scale data table for a guitar fingerboard according to an embodiment of the present disclosure; and

FIG. 4 is a schematic structural diagram illustrating a terminal according to an embodiment of the present disclosure.

### DETAILED DESCRIPTION OF EMBODIMENTS

In order to make objectives, technical solutions and advantages of embodiments of the present disclosure clearer, the technical solutions of the embodiments of the present disclosure are clearly and completely described hereinafter in conjunction with the drawings of the embodiments of the present disclosure. Apparently, the described embodiments are only some embodiments of the present disclosure, rather than all embodiments. All the other embodiments obtained by those skilled in the art based on the embodiments in the present disclosure without any creative work fall within the protection scope of the present disclosure.

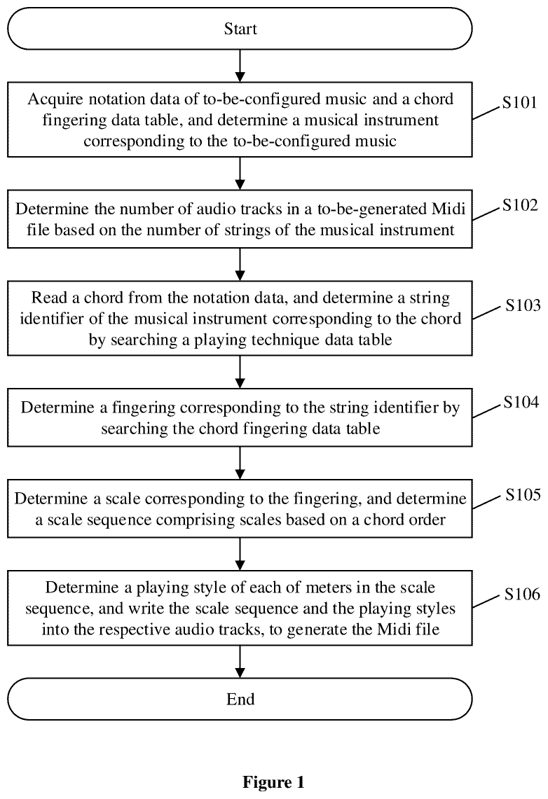

Reference is made to FIG. 1, which is a flow chart illustrating a method for generating a Midi file according to an embodiment of the present disclosure. The method includes the following steps S101 to S106.

In step S101, notation data of to-be-configured music is acquired, and a musical instrument corresponding to the to-be-configured music is determined.

The step S101 aims to acquire the notation data of the to-be-configured music, and determine the musical instrument to be played by a user. The notation data is a combination of symbols indicating pitch or rhythm of music, such as the numbered notation, the staff notation, or the guitar notation that are generally known. The notation data mainly includes chords in the notation, and may further include the number of beats (beating) per minute (BPM), and the like. The to-be-configured music may be music to be played by the user, or music designated by the user. In addition, while determining the musical instrument, a playing technique of the musical instrument is determined for subsequently determining finger strength. In the step, the musical instrument mainly refers to a stringed musical instrument, including but not limited to, a ukulele, a guitar, and the like.

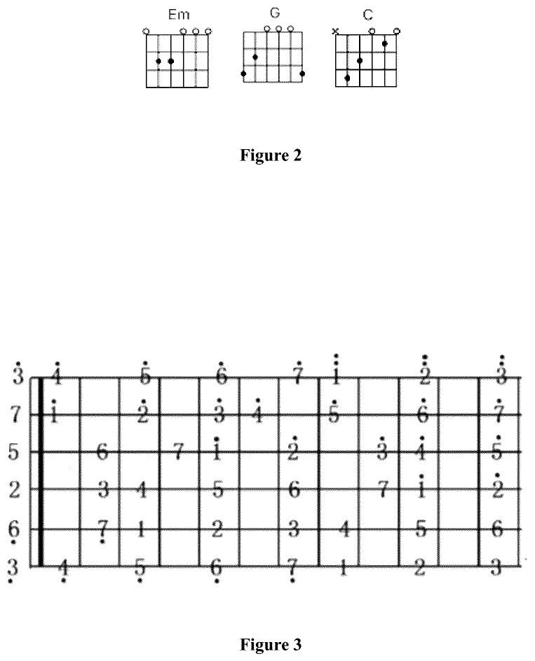

A chord fingering data table includes chords and respective fingerings, strings that are to be not played, and the like. Reference is made to FIG. 2, which is a schematic diagram illustrating some chords and respective fingerings according to an embodiment of the present disclosure. The chords include three chords, i.e., Em chord, G chord, and C chord. Therefore, a fingering corresponding to a chord is determined by directly searching the chord fingering data table.

In the embodiment, the chord fingering data table is already stored before step S101. The chord fingering data table is generated in a previous step in the embodiment, or acquired in a previous step in the embodiment. Alternatively, the chord fingering data table is generated or acquired before this embodiment. How the chord fingering data table is generated or acquired is not limited herein. The chord fingering data table mainly includes a chord name, a fingering, and an idle string. Table 1 is the chord fingering data table corresponding to the three chords as shown in FIG. 2.

TABLE 1
chord fingering data table

| | | Idle |
|---|---|---|
| Chord name | Fingering | string |
| Em chord | 5th string-1st fret, 4th string-1st fret | |
| G chord | 6th string-3rd fret, 5th string-2nd fret, 1st string- | |
| | 3rd fret | |
| C chord | 5th string-3rd fret, 4th string-2nd fret, 2nd string- | 6 |
| | 1st fret | |

The chord fingering data table in Table 1 shows only some chords. Those skilled in the art can determine fingerings corresponding to chords to playing techniques for a musical instrument. In other words, those skilled in the art can determine a fingering corresponding to a chord by searching the chord fingering data table in this step.

In another embodiment, the notation data and the musical instrument of the to-be configured music are inputted by the user, or acquired and determined by parsing content inputted by the user. For example, a name of a to-be-played song is inputted by the user, notation data corresponding to the name of the song is directly acquired, and musical instruments are recommended for the user to choose. Alternately, playing techniques corresponding to the notation data or available musical instruments are provided for the user to choose. It should be understood that different musical instruments may correspond to different playing techniques, which is not detailed herein.

In step S102, the number of audio tracks in the Midi file is determined based on the number of strings of the musical instrument.

The step S102 aims to determine the number of the audio tracks. In general, the number of the strings of the musical instrument is equal to the number of the audio tracks. For example, the guitar corresponds to six audio tracks, and the ukulele corresponds to four audio tracks.

The certain number of audio tracks may be preconfigured. In this step, the number of to-be occupied audio tracks is determined based on the number of the strings of the musical instrument, and the audio tracks are configured for the musical instrument.

In another embodiment, after the number of the strings of the musical instrument is determined, the audio tracks having the same number as the strings are configured.

In step S103, a chord is read from the notation data, and a string identifier of the musical instrument corresponding to the chord is determined by searching a playing technique data table.

The step S103 aims to determine the string identifier corresponding to the chord read from the notation data. The playing technique data table includes chords, respective string identifiers, and a duration corresponding to each of the string identifiers. It should be noted that the playing style corresponding to the same chord varies with the playing technique. Reference is made to Tables 2 and 3. Table 2 shows some chords and respective playing styles for fingerstyle. Table 3 shows some chords and respective playing styles for sweep-picking.

TABLE 2
Chords and respective playing styles for fingerstyle

| Chord | |
|---|---|
| name | Playing style |
| C chord | 5th string for 0.5 beat, 3rd string for 0.5 beat, 2nd string |
| | for 0.5 beat, 3rd string for 0.5 beat, 1st string for 0.5 beat, |
| | 3rd string for 0.5 beat, 2nd string for 0.5 beat, 3rd string |
| | for 0.5 beat |
| G chord | 6th string for 0.5 beat, 3rd string for 0.5 beat, 2nd string |
| | for 0.5 beat, 3rd string for 0.5 beat, 1st string for 0.5 beat, |
| | 3rd string for 0.5 beat, 2nd string for 0.5 beat, 3rd string |
| | for 0.5 beat |

TABLE 3
Chords and respective playing styles for sweep-picking

| Chord | |
|---|---|
| name | Playing style |
| C chord | 5th string 4th string 3rd string for 1 beat, 4th string 3rd string |
| | 2nd string 1st string for 0.5 beat, 4th string 3rd string 2nd |
| | string 1st string for 0.25 beat, 1st string 2nd string 3rd string |
| | 4th string for 0.25 beat |
| G chord | 6th string 5th string 4th string 3rd string for 1 beat, 4th string 3rd |
| | string 2nd string 1st string for 0.5 beat, 4th string 3rd string 2nd |
| | string 1st string for 0.25 beat, 1st string 2nd string 3rd string 4th |
| | string for 0.25 beat |

From Tables 2 and 3, it can be seen that the playing style corresponding to the C chord varies with the playing technique. Therefore, in the step, the chord is read from the notation data, and a string identifier corresponding to the chord for a beat is determined by searching the playing technique data table based on the playing style. For example, if a chord for a first beat in the notation data is C chord, it is found that in the Table 3 that 5th string, 4th string, and 3rd string are to be swept with a duration of one beat. In addition, the C chord in Table 3 is taken as an example. 5th string, 4th string, and 3rd string are played corresponding to the C chord for the first beat. If a chord for the second beat is still the C chord, 4th string 3rd string 2nd string 1st string for 0.5 beat, 4th string 3rd string 2nd string 1st string for 0.25 beat, and 1st string 2nd string 3rd string 4th string for 0.25 beat are played. In this way, the C chord for the second beat is played.

In step S104, a fingering corresponding to the chord is determined by searching the chord fingering data table for the string identifier.

In this step, the chord fingering data table is searched for the string identifier determined in the previous step, in order to determine the fingering corresponding to the chord.

In addition, it should be noted that the chord fingering data table includes a mapping relationship between chords and fingerings. That is, any mapping relationship between chords and fingerings serves as the chord fingering data table in the step. The mapping relationship is not limited in the table from. Alternatively, the mapping relationship is in a database, or in other data format for easily searching.

In step S105, a scale corresponding to the chord is determined based on the fingering, and a scale sequence including scales is determined based on a chord order.

The step S105 aims to determine the scale sequence corresponding to fingerings. Specifically, the fingering corresponding to each of the chords is determined as described above, and the scale corresponding to the fingering is determined. In this way, scales corresponding to all the chords are determined, and the scale sequence is acquired based on the chord order in the notation data. It should be noted that the scale corresponding to each of the chords is acquired according to the above process, and the scale sequence corresponds to all the chords in the notation data. That is, the chord corresponds to the scale, and the notation data corresponds to the scale sequence, and each of the chords is of one beat.

In this step, the scale is determined based on a scale data table of the musical instrument. Scale data tables of various musical instruments are significantly different. The guitar is taken as an example, as shown in FIG. 3. FIG. 3 is a schematic diagram illustrating a scale data table of a guitar fingerboard according to an embodiment of the present disclosure, which illustrates a correspondence among string identifiers, fret identifiers, and scales. For example, in FIG. 3, 1st string 0 fret corresponds to high-3, 1st string 1 fret corresponds to high-4, and 2nd string 0 fret corresponds to the middle-7. The fingering includes both the string identifier and the fret identifier, and the scale corresponding to each of the chords is determined by searching the scale data table in the step. Further, the scale sequence corresponding to the notation data including all the chords is determined based on the chord order in which the chords are played.

In step S106, a playing style of each of meters in the scale sequence is determined, and the scale sequence and the playing styles are written into each of the respective audio tracks, to generate the Midi file.

In the step S106, the playing style of each of the meters is determined. The playing style includes the finger strength and the number of times that the meters is to be played. Firstly, the playing style of each of the meters is determined. An arrangement of strongness and weakness is determined based on the number of beats per minute in the notation data. A first beat to each measure in the notation data is a strongest beat, and other beats to the measure with strong note are strong beats, and a beat unit without strong note is a weak beat. Meters refer to regularly recurring strong and weak beats in a certain order of equal length, and are measured in bars. For example, the meter including two beats refers to two fourths when represented by quarter note. Common time signatures and respective arrangements in the notation data are as follows.

A time signature 2/4 has only two beats per measure, the first beat is strong and the second beat is weak.

A time signature 3/4 has only three beats per measure, the first beat is strong, the second beat is weak and the third beat is weak.

A time signature 4/4 has only four beats per measure (that is divided by two exactly), the first beat is strongest, the second beat is weak, the third beat is strong, and the fourth beat is weak.

A time signature 6/8 has only six beats per measure (that is divided by two exactly), the first beat is strongest, the second beat is weak, the third beat is weak, the fourth beat is strong, the fifth beat is weak, and the sixth beat is weak.

The number of repeats varies with the playing technique. For example, the strong beat may be played once, twice, or four times. The playing technique is the style or fingering for playing the musical instrument, including but not limited to the sweep-picking, the fingerstyle and the like. The finger strength of each of the beats in the scale sequence is determined based on the arrangement of strongness and weakness and the number of times that each of the beats is to be played. The playing styles of each of the meters in the scale sequence corresponding to two different playing techniques are determined as follows.

In a case that the playing technique is the fingerstyle, the finger strength is determined by the following steps 1 and 2.

In step 1, for each of the beats, a finger strength for playing the beat for the first time is determined based on the arrangement of strongness and weakness.

In step 2, the finger strength when the beat is to be played subsequently is determined as weak.

Each of the beats is played multiple times. In the fingerstyle, regardless of how many times the beat is to be played, the finger strength of the beat to be played for the first time corresponds to the arrangement of strongness and weakness, and is determined as weak when played subsequently. For example, if the strong beat is to be played twice, the first beat is determined as strong and the second beat is determined as weak. If the strong beat is played four times, the first beat is determined as strong, and the remaining three beats are determined as weak.

For another example, the playing technique is the sweep-picking. The finger strength for the sweep-picking is determined differently from the fingerstyle. The finger strength for the sweep-picking is determined as follows.

In step 1, an initial finger strength is determined based on the arrangement of strongness and weakness.

In step 2, finger strength of the scales for certain number of beats in the scale sequence are arranged in descending order from the initial finger strength as time goes on.

For the sweep-picking, the initial finger strength depends on the first beat in the arrangement of strongness and weakness. Multiple strings are simultaneously played during one sweep motion Therefore, subsequent beats are decreasingly weak, i.e., all weaker than the first beat as time goes on.

In order to more clearly illustrate the difference in determination of the finger strength for the two playing techniques, a finger strength value is introduced as a reference below, and a beat strength value table is first acquired. In the beat strength value table, beats with different finger strengths, such as the strongest beat, the strong beat, and the weak beat, each correspond to a finger strength range. In general, eight strengths correspond to a total of 128 finger strength values ranging from 0 to 127. A greater finger strength value indicates the stronger finger strength. In another embodiment, the finger strength may be represented in other ways by those skilled in the art, which is not listed herein.

After the beat strength value table is acquired, for each of the beats, a strength of the beat is determined based on the arrangement of strongness and weakness, a finger strength value corresponding to the strength of the beat is determined based on the beat strength value table, and a mapping relationship between the finger strength value and the number of times that the beat is played is established to obtain the finger strength of each of the meters in the scale sequence. After the finger strength value of each of the beats is determined to obtain the finger strength of the meter, the finger strength of the scale including the meter is further determined. Finally, the finger strength of the scale sequence including all the scales is determined.

In a case that the playing technique is the fingerstyle, the time signature 4/4 has the arrangement of strongest, weak, strong and weak beats, in order to adapt the Midi file to the actual rhythm as much as possible. The finger strength is determined as 80, 40, 60 and 40 per cycle, which indicates that the strongest beat corresponds to a finger strength value of 80, the weak beat corresponds to a finger strength value of 40, and the strong beat corresponds to a finger strength value of 60. The time signature 3/4 has the arrangement of strong, weak, weak beats, and then the finger strength is determined as 80, 40 and 40 per cycle.

In a case that the playing technique is the sweep-picking, a first scale corresponds to a strongest beat with the strength value of 80. Assuming that the meters are progressively weaker with a decrement of 10, the strength value varies from 80 to 70, and then 60 and finally 50.

For example, a scale sequence includes a scale 1, a scale 3 and a scale 5. The scale 1 corresponds to an audio track 5 with the initial finger strength of 80 from 0 ms. The scale 3 corresponds to an audio track 4 with a finger strength of 70 from 1 ms. The scale 5 corresponds to an audio track 5 with a finger strength of 60 from 2 s. The finger strength of the remaining audio tracks is determined as 0. It should further be noted that a strength difference varies within each cycle. A strength difference between adjacent scales within each cycle is set to be constant, in order to generate a sound closer to the original sound. As described above, the strength difference between adjacent scales within each cycle is set to 10.

It can be seen that in the embodiment, the scale and the playing style corresponding to each of the chords in the notation data are determined as described above. That is, after scales and playing style corresponding to all the chords in the notation data are determined as described above, the complete scale sequence corresponding to the notation data can be obtained. In a specific implementation process, the above process is performed for the chords in the notation data in parallel or serially. Alternatively, the notation data is segmented, and then the above process is performed for the segmented notation data. Under the premise that the process described above is performed for all the chords in the notation data to obtain the scale sequence and the playing style, any parallel processing manner or serial processing manner fall within the protection scope of the present disclosure.

Finally, the scale sequence and the finger strength of meters are written into the respective audio tracks to generate the Midi file. It can be seen that the Midi file at least includes the scale sequence and the finger strength of each of meters. In addition, for the same notation data, multiple Midi files may be configured for different musical instruments, and thus various options of the musical instrument are configured on a display interface displaying the Midi file for users to choose. Similarly, various options of the playing techniques, a playing style of the notation data, and other parameters may be configured for users to choose. In this case, the Midi file may include scale sequences and finger strengths corresponding to various playing techniques. In order to facilitate an understanding of the notation data, the number of beats per minute, a time signature of the notation data, the playing technique and other relevant parameters are added to the Midi file.

According to the embodiment of the present disclosure, the generated Midi file includes the fingering, the playing technique, the scale, and the finger strength, for the player to learn how to play each of the chords and then play the chords steadily with the Midi file. The player can perform a quick switch between the chords, rapidly master various playing techniques, and play and sing simultaneously. Therefore, the method effectively assists the player in practicing the musical instrument.

Based on the above embodiments, in a preferred embodiment, while acquiring the notation data of the to-be-configured music and determining the musical instrument corresponding to the to-be-configured music, the number of beats per minute corresponding to the notation data is directly determined. Therefore, after the Midi file is generated, the number of beats per minute is written into the Midi file, thereby enriching music information included in the Midi file and assisting the player in practicing the musical instrument.

Based on the above embodiments, in a preferred embodiment, the playing technique data table corresponding to each of the musical instruments is established based on the rhythms corresponding to the musical instrument before being searched for the string identifier of the musical instrument corresponding to the chord.

The embodiment aims to establish the playing technique data table. It should be noted that in the embodiment, the playing technique data table is established only before being searched for the string identifier of the musical instrument corresponding to the chord. The playing technique data table is specific to the musical instrument.

Based on the above embodiments, in a preferred embodiment, before determining the fingering corresponding to the chord by searching the chord fingering data table for the string identifier, fingerings and respective chords of the musical instrument are collected to generate the chord fingering data table.

The embodiment aims to establish the chord fingering data table. It should be noted that in the embodiment, the chord fingering data table is established only before searched.

Specifically, the playing technique data table and the chord fingering data table are established and are stored in a device for generating the Midi file or a cloud database as a basic database for generating the Midi file, so that the playing technique data table and the chord fingering data table can be rapidly searched when the Midi file is generated. Therefore, the Midi file can be generated efficiently.

A computer-readable storage medium is further provided according to the present disclosure. The computer-readable storage medium stores a computer program that, when being executed, performs the method according to the foregoing embodiments. The storage medium may include various media that can store program codes, such as a USB flash disk, a mobile hard disk, a Read-Only Memory (ROM), a Random Access Memory (RAM), a disk, or an optical disc.

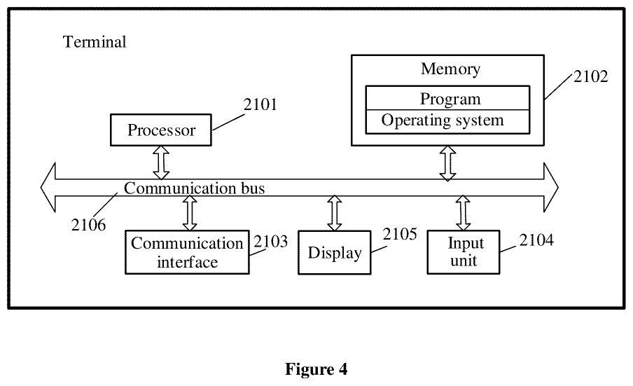

A terminal is further provided according to the present disclosure. The terminal includes a memory and a processor. The memory is configured to store a computer program. The processor is configured to perform, when executing the computer program in the memory, the method according to the foregoing embodiments. The terminal may further include components such as various network interfaces and a power supply. Reference is made to FIG. 4, which is a schematic structural diagram illustrating the terminal according to an embodiment of the present disclosure. The terminal according to the embodiment may include a processor 2101 and a memory 2102.

In an embodiment, the terminal may further include a communication interface 2103, an input unit 2104, a display 2105, and a communication bus 2106.

The processor 2101, the memory 2102, the communication interface 2103, the input unit 2104, and the display 2105 communicate with each other via the communication bus 2106.

In the embodiment of the present embodiment, the processor 2101 is a central processing unit (CPU), an application-specific integrated circuit, a digital signal processor, a field programmable gate array, or other programmable logic devices.

The processor invokes the program stored in memory 2102. Specifically, the processor performs the operations performed by the terminal in the foregoing embodiments.

The memory 2102 is configured to store one or more programs. The program may include program codes, and the program codes include computer operation instructions. The memory according to the embodiment of the present disclosure stores at least a program for: acquiring notation data of to-be-configured music, and determining a musical instrument corresponding to the to-be-configured music; determining the number of audio tracks in the Midi file based on the number of strings of the musical instrument; reading a chord from the notation data, and determining a string identifier of the musical instrument corresponding to the chord by searching a playing technique data table; determining a fingering corresponding to the string identifier by searching a chord fingering data table; determining a scale corresponding to the chord based on the fingering, and determining a scale sequence comprising scales based on a chord order; and determining a playing style of each of meters in the scale sequence, and writing the scale sequence and the playing styles into the respective audio tracks, to generate the Midi file.

In an embodiment, the memory 2102 includes a program storage area and a data storage area. The program storage area stores an operating system, an application program for at least one function, and the like. The data storage area stores data created during use of a computer.

In addition, the memory 2102 includes a high-speed random-access memory and a non-volatile memory, e.g., at least one disk memory device or other volatile solid-state storage device.

The communication interface 2103 is an interface of a communication module, e.g., an interface of a GSM module.

The terminal according to the present disclosure further includes a display 2105, an input unit 2104, and the like.

The structure of the terminal shown in FIG. 4 is not intended to limit the terminal according to the embodiments of the present disclosure. In practice, the terminal may include more or less components than those shown in FIG. 4, or combinations of some components.

The principle and embodiments of the present disclosure are described through specific examples herein. The description of the above embodiments is only used to facilitate an understanding of the method and the core concept of the present disclosure. It should be noted that several improvements and modifications can be made to the present disclosure by those skilled in the art without departing from the principles of the present disclosure. These improvements and modifications also fall within the protection scope of the claims of the present disclosure.

It should be further noted that the relational terms such as “first” and “second” are only used herein to distinguish one entity or operation from another, rather than to necessitate or imply that the actual relationship or order exists between the entities or operations. Furthermore, terms “include”, “comprise” or any other variants thereof are intended to be non-exclusive. Therefore, a process, method, article or device including a series of elements includes not only the elements but also other elements that are not enumerated or other elements inherent in such process, method, article or device. Unless expressively limited otherwise, a process, method, article or device limited by “comprising/including a(n) . . . ” does not exclude existence of another identical element in such process, method, article or device.

1. A method for generating a Midi file, comprising:
acquiring notation data of to-be-configured music, and determining a musical instrument corresponding to the to-be-configured music;
determining the number of audio tracks in the Midi file based on the number of strings of the musical instrument;
reading a chord from the notation data, and determining a string identifier of the musical instrument corresponding to the chord by searching a playing technique data table;
determining a fingering corresponding to the string identifier by searching a chord fingering data table;
determining a scale corresponding to the chord based on the fingering, and determining a scale sequence comprising scales based on a chord order; and
determining a playing style of each of meters in the scale sequence, and writing the scale sequence and the playing styles into the respective audio tracks, to generate the Midi file.

2. The method for generating the Midi file according to claim 1, wherein the playing style comprises the number of times and finger strength, and the determining the playing style of each of the meters in the scale sequence comprises:
determining a playing technique of the musical instrument and the number of beats per minute corresponding to the notation data;
determining an arrangement of strongness and weakness based on the number of beats per minute;
determining the number of times that each of the beats is to be played based on the playing technique; and
determining the finger strength of each of meters in the scale sequence based on the arrangement and the number of times that each of the beats is to be played.

3. The method for generating the Midi file according to claim 2, wherein the playing technique is fingerstyle, and the determining the finger strength of each of meters in the scale sequence based on the arrangement and the number of times that each of the beats is to be played comprises:
determining, for each of the beats based on the arrangement, the finger strength when the beat is to be played for a first time; and
determining the finger strength when the beat is played subsequently as weak.

4. The method for generating the Midi file according to claim 2, wherein the playing technique is sweep-picking, and the determining the finger strength of each of meters in the scale sequence based on the arrangement and the number of times that each of the beats is to be played comprises:
determining initial finger strength based on the arrangement; and
arranging finger strength of the scales for certain number of beats in the scale sequence in descending order from the initial finger strength as time goes on.

5. The method for generating the Midi file according to claim 1, wherein the determining the finger strength of each of meters in the scale sequence based on the arrangement and the number of times that each of the beats is to be played comprises:
acquiring a beat strength value table;
determining, for each of the beats, strength of the beat when to be played each time based on the arrangement;
determining a finger strength value corresponding to the strength of the beat from the beat strength value table; and
establishing a mapping relationship between the finger strength value and the number of times that the beat is to be played, to obtain the finger strength of each of the meters in the scale sequence.

6. The method for generating the Midi file according to claim 1, further comprising:
establishing the playing technique data table corresponding to the musical instrument based on playing techniques of the musical instrument, before the determining the string identifier of the musical instrument corresponding to the chord by searching the playing technique data table.

7. The method for generating the Midi file according to claim 1, further comprising:
collecting fingerings and respective chords of the musical instrument to generate the chord fingering data table, before the determining the fingering corresponding to the chord by searching the chord fingering data table for the string identifier.

8. The method for generating the Midi file according to claim 2, further comprising:
adding the number of beats per minute, a time signature of the notation data, and the playing technique to the Midi file, after the Midi file is generated.

9. A computer-readable storage medium, storing a computer program, wherein
the computer program, when being executed by a processor, performs the method for generating the Midi file according to claim 1.

10. A terminal, comprising:
a memory configured to store a computer program; and
a processor configured to invoke the computer program stored in the memory to perform the method for generating the Midi file according to claim 1.
